(19) United States
(12) Patent Application Publication
(10) Pub. No.: US 2015/0267615 A1
(43) Pub. Date: Sep. 24, 2015

(54) Alternative fuel rocket augmentation device

(71) Applicant: Michael Marion McCulley, Benicia, CA (US)

(72) Inventor: Michael Marion McCulley, Benicia, CA (US)

(21) Appl. No.: 14/663,454

(22) Filed: Mar. 20, 2015

Related U.S. Application Data
(60) Provisional application No. 61/968,891, filed on Mar. 21, 2014.

(51) Int. Cl. F02C 7/04; F02C 7/264; F02C 3/04

(52) U.S. Cl. CPC F02C 7/04; F02C 3/04; F02C 7/264; F05D 2220/80; F05D 2230/80; F05D 2220/323

(57) ABSTRACT

A rocket engine tail cone for creating a propulsive force used as augmentation for turbomachinery that uses alternative fuel created by combining compressed environmental air as usable liquid oxygen or gaseous oxygen and a fuel propellant mixture. The rocket engine will inject liquid oxygen or gaseous oxygen into its combustion chamber as an oxidizer and exhaust gas and or jet fuel as a propellant mixture and will employ a spark from an electronic ignition plug as an igniter.

### FIELD OF THE INVENTION

The present invention relates generally to rocket engine and jet engine propulsion.

### BACKGROUND OF THE INVENTION

Conventional aircraft must store all vehicle fuel for the turbomachinery to utilize while operating. This is usually loaded onboard the aircraft while on the ground, which the aircraft must then carry with it on its journey. A preferred alternative would be to generate part of the fuel source while operating, which would then be combined in new ways in order to augment aerospace propulsion.

### SUMMARY OF THE INVENTION

The present invention incorporates a rocket engine tail cone that is used as propulsion augmentation for turbomachinery. The alternative fuel rocket augmentation device uses an alternative fuel mixture combination of liquid or gaseous oxygen created by compressing environmental air outside of jet aircraft into usable liquid oxygen or gaseous oxygen as an oxidizer and a fuel mixture propellant. Liquid oxygen or gaseous oxygen will be collected and compressed by an oxygen converter, such as a liquid oxygen based breathing apparatus converter, and collected into an onboard tank for immediate use or stored for later use. The rocket engine will inject the liquid oxygen and or gaseous oxygen mixture into a combustion chamber as an oxidizer as well as turbomachinery exhaust gas, such as bleed air, and or a jet fuel mixture as a propellant mixture and will employ an ignition spark from an electronic ignition plug as an igniter.

The oxygen, fuel mixture will be atomized in one or more spray rings inside a combustion chamber. The ignition plug will draw electrical power from the turbomachinery and ignite the oxygen, fuel mixture in the combustion chamber. The ignited rocket exhaust will escape through a rocket nozzle coaxially creating augmented aircraft propulsion. The alternative fuel rocket augmentation device will be installed aft of a jet engine and inside the turbine exhaust chamber coaxially, such as a tail cone, in order to augment the propulsion in the most efficient manner without creating additional drag on the aerospace vehicles.

The alternative fuel rocket augmentation device can be installed into new jet engine systems or alternatively retrofit existing jet engines. The alternative fuel rocket augmentation device will draw electrical power and fuel, exhaust from the turbomachinery, such as jet engine combustion bleed air, and draw in environmental air through an oxygen converter. Preferably using as little or no stored aircraft jet fuel as possible, the alternative fuel rocket augmentation device will augment propulsion similar to an afterburner but without the extreme expenditure of jet fuel.

The alternative fuel rocket augmentation device could operate continually or for short periods in order to facilitate aircraft take off or acceleration. Alternative fuels to be used in the combustion chamber are also available, such as natural gas or propane, which would be stored in additional tanks. The augmented aircraft propulsion will in turn prove to increase overall fuel efficiency in aerospace propulsion.

### BRIEF DESCRIPTION OF THE FIGURES

FIG. 1 represents the alternative fuel rocket augmentation device, side view.

FIG. 2 represents the alternative fuel rocket augmentation device, front view.

### DETAILED DESCRIPTION OF THE FIGURES

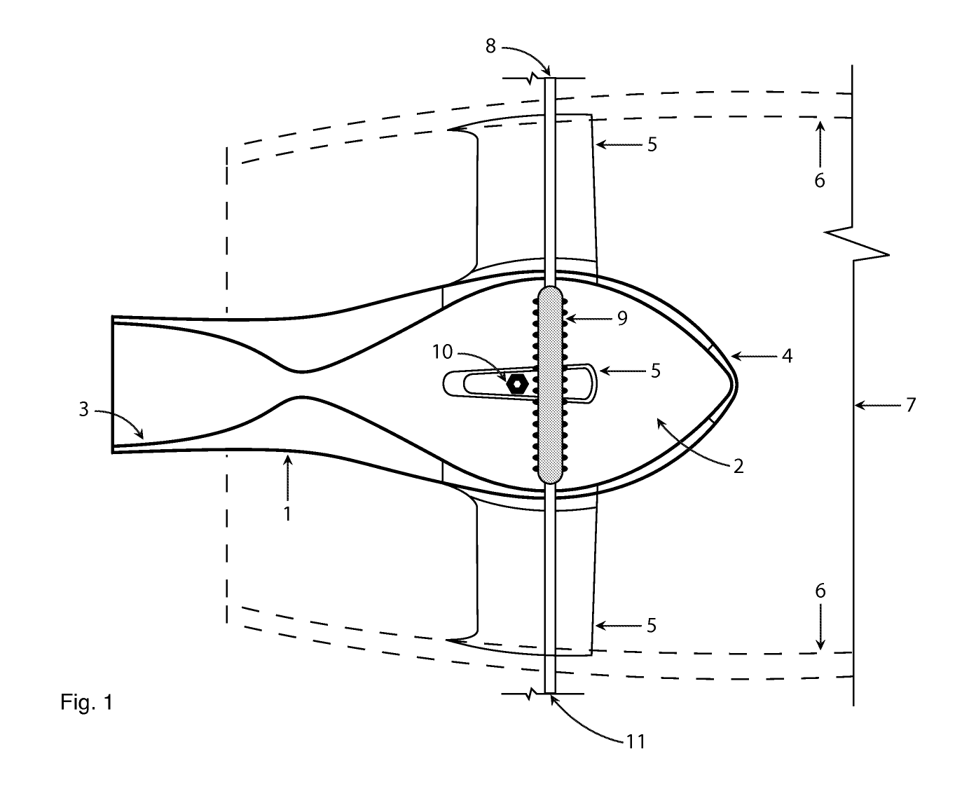

FIG. 1 represents the alternative fuel rocket augmentation device, side view, with half of the tail cone housing 1 cut away in order to show internal components. A combustion chamber 2 has an access plate 4 for internal components. The tail cone housing 1 is connected to the turbine exhaust section of turbomachinery 6 by connection fairings 5. The connection fairings 5 also connect liquid or gaseous oxygen mixture input 8 and exhaust gas or jet fuel mixture input 11. The connection fairings 5 also connect an electronic ignition plug 10. The liquid or gaseous oxygen mixture and exhaust gas or jet fuel mixture are combined and atomized by a spray ring 9. The electronic ignition plug 10 ignites the mixture in the combustion chamber 2. The combustion chamber 2 and a rocket nozzle 3 direct rocket pressure away from the exhaust section of turbomachinery 6 coaxially. A cut away 7 shows where the alternative fuel rocket augmentation device will be positioned coaxially inside the turbine exhaust section of turbomachinery 6.

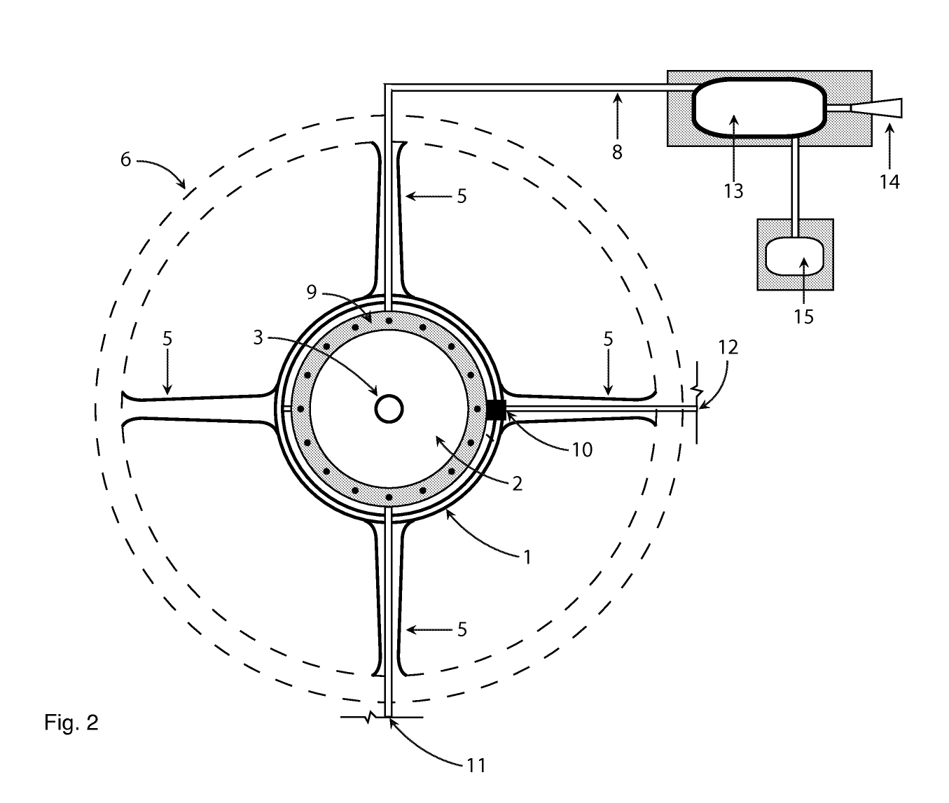

FIG. 2 represents the alternative fuel rocket augmentation device, front view, with the front of the tail cone housing 1 cut away in order to show internal components. The tail cone housing 1 is connected to the turbine exhaust section of turbomachinery 6 by connection fairings 5. The connection fairings 5 also connect liquid or gaseous oxygen mixture input 8 and exhaust gas or jet fuel mixture input 11. An environmental air input 14 collects air and feeds into an oxygen converter 13 , such as a liquid oxygen based breathing apparatus converter 13, which compresses the air into a usable liquid or gaseous oxygen mixture, which feeds into input 8. The usable liquid or gaseous oxygen mixture can additionally be collected into an onboard tank 15 for immediate use by the rocket engine or stored for later use. The connection fairings 5 also connect an electronic ignition plug 10 and electronic input 12. The liquid or gaseous oxygen mixture and exhaust gas or jet fuel mixture are combined and atomized by a spray ring 9. The electronic ignition plug 10 ignites the mixture in the combustion chamber 2. The combustion chamber 2 and a rocket nozzle 3 direct rocket pressure away from the turbine exhaust section of turbomachinery 6 coaxially.

What is claimed is:

1. A rocket engine for creating a propulsive force for turbomachinery, wherein an alternative fuel is created by combining compressed environmental air into a usable liquid oxygen or gaseous oxygen mixture as an oxidizer, wherein exhaust gas, such as bleed air, or a jet fuel mixture is used as a propellant, wherein a spark from an electronic ignition plug is used as an igniter.

2. A rocket engine according to claim 1, wherein the oxidizer is created by compressing the environmental air outside of aerospace vehicles into the usable liquid oxygen or gaseous oxygen mixture.

3. A rocket engine according to claim 1, wherein the rocket engine can be installed into a new jet engine system or alternatively retrofit an existing jet engine, wherein the rocket engine can be installed as a tail cone aft of the turbomachinery and inside a turbine exhaust section coaxially.

4. A rocket engine according to claim 1, wherein a combustion chamber has an access plate for internal components, wherein a tail cone housing is connected to the turbine exhaust section of the turbomachinery by connection fairings, wherein the connection fairings also connect a liquid or gaseous oxygen mixture input and an exhaust gas or jet fuel mixture input, wherein the connection fairings also connect an electronic ignition plug, wherein the connection fairings also connect an electronic input, wherein the liquid or gaseous oxygen mixture and the exhaust gas or jet fuel mixture are both combined and atomized by a spray ring, wherein the electronic ignition plug ignites the mixtures in the combustion chamber, wherein the combustion chamber and a rocket nozzle direct rocket pressure away from the turbine exhaust section of the turbomachinery coaxially.

5. A rocket engine according to claim 1, wherein an environmental air input collects environmental air, wherein an oxygen converter, such as a liquid oxygen based breathing apparatus converter, compresses the air into the usable liquid or gaseous oxygen mixture, wherein the usable liquid or gaseous oxygen mixture can be collected into an onboard tank for immediate use by the rocket engine or stored for later use.

6. A method of creating an oxidizer for a rocket engine by compressing environmental air outside of aerospace vehicles into a usable liquid oxygen or gaseous oxygen mixture, wherein an oxygen converter, such as a liquid oxygen based breathing apparatus converter, compresses the air into the usable liquid or gaseous oxygen mixture, wherein the usable liquid or gaseous oxygen mixture can be collected into an onboard tank for immediate use by the rocket engine or stored for later use.
